(19) United States
(12) Patent Application Publication
(10) Pub. No.: US 2014/0116773 A1
(43) Pub. Date: May 1, 2014

(54) ELECTRONIC DEVICE WITH AIR BAFFLE ASSEMBLY

(71) Applicant: HON HAI PRECISION INDUSTRY CO., LTD., New Taipei (TW)

(72) Inventor: CHENG-HSIU YANG, New Taipei (TW)

(73) Assignee: HON HAI PRECISION INDUSTRY CO., LTD., New Taipei (TW)

(21) Appl. No.: 13/751,525

(22) Filed: Jan. 28, 2013

(30) Foreign Application Priority Data
Oct. 31, 2012 (TW) 101140230

(51) Int. Cl. H02G 15/013

(52) U.S. Cl. CPC H02G 15/013
USPC 174/650

(57) ABSTRACT

An electronic device includes a plate and an air baffle assembly. The plate defines a through hole. The air baffle assembly is mounted in the through hole. The air baffle assembly includes a base mounted to a portion of the plate bounding the through hole, and a number of bristle-shaped flexible air baffle portions formed on the base to partially cover the through hole.

### BACKGROUND

1. Technical Field

The present disclosure relates to an electronic device including an air baffle assembly.

2. Description of Related Art

An electronic device, such as a server, has holes to allow cables and hot plug components to extend or pass through. However, when the electronic device is operating, the holes can cause air back flowing and turbulence, which will adversely influence heat dissipation in the electronic device.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partial, assembled, isometric view of a first embodiment of an electronic device, wherein the electronic device includes a chassis, and an air baffle assembly including two air baffle members.

FIG. 2 is an isometric view of the chassis of FIG. 1.

FIG. 3 is an enlarged view of one of the air baffle members of FIG. 1.

FIG. 4 is an assembled, plan view of the air baffle assembly of FIG. 1 together with a plate.

FIG. 5 is an assembled, plan view of an air baffle assembly and a plate of another embodiment of an electronic device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

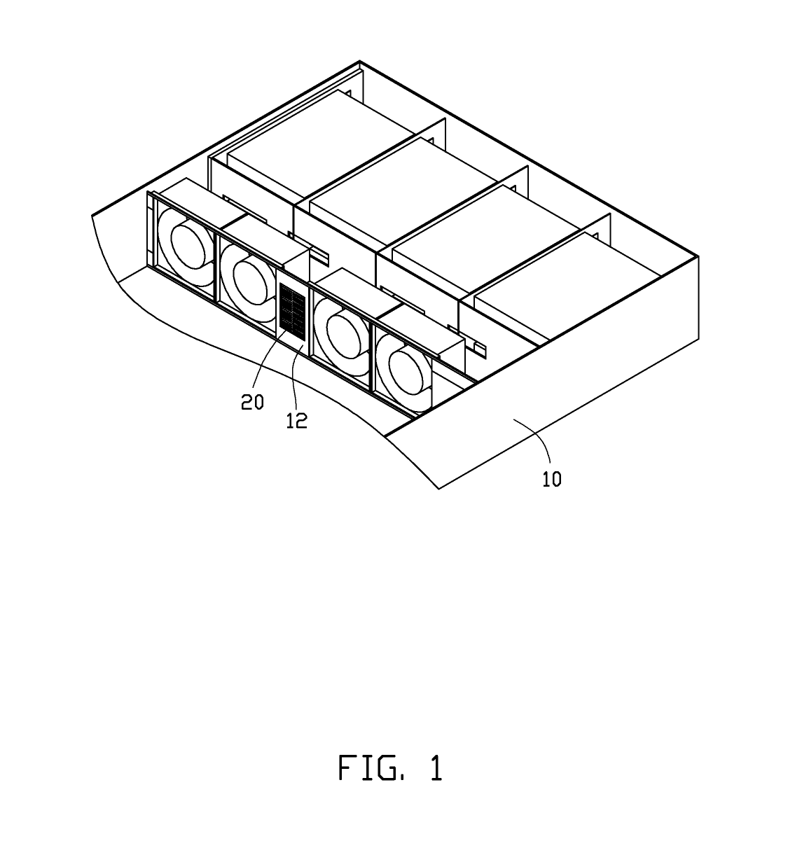

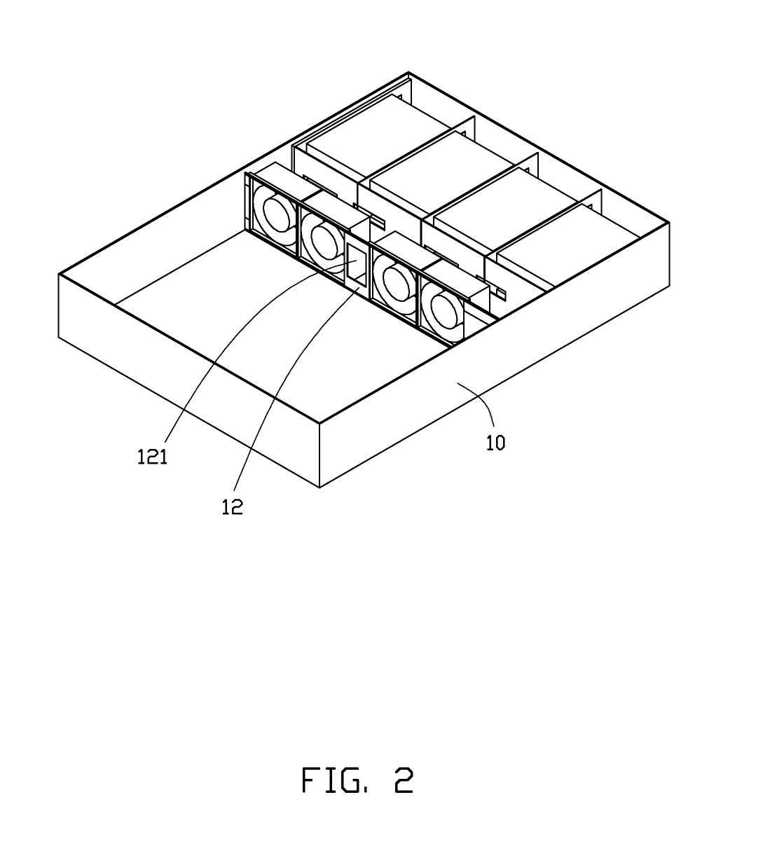

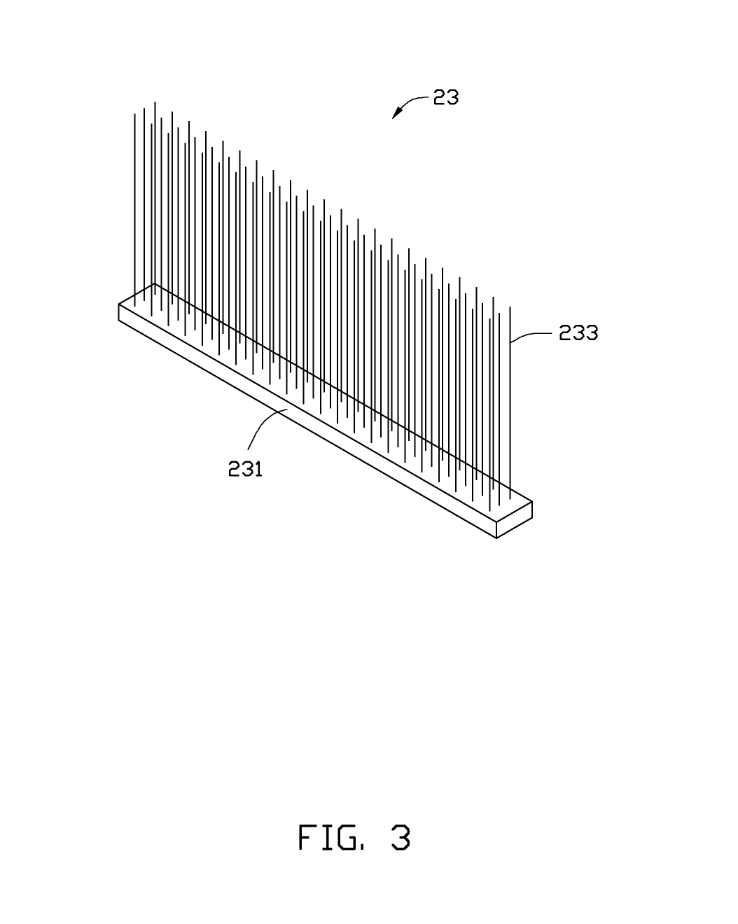

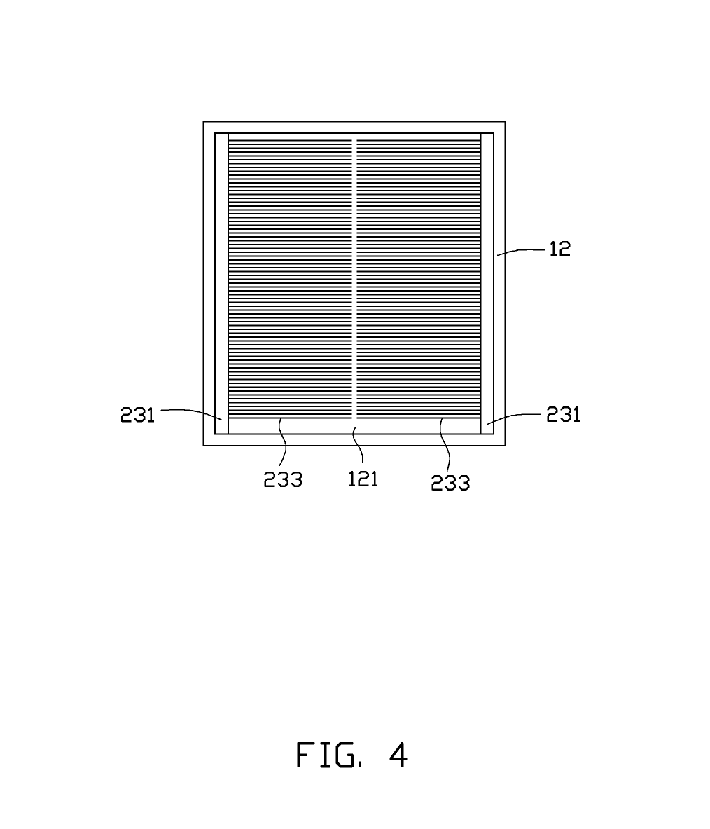

FIGS. 1 to 4 show a first embodiment of an electronic device. The electronic device includes a chassis 10 and an air baffle assembly 20.

A plate 12 defining a rectangular through hole 121 is mounted in the chassis 10.

The air baffle assembly 20 includes two air baffle members 23. Each air baffle member 23 includes a rectangular flexible base 231 made of heat-resistant plastic, and a plurality of bristle-shaped flexible air baffle portions 233 made of heat-resistant plastic formed on a first side of the base 231.

In assembly, second sides of the bases 231 facing away from the air baffle portions 233 are affixed to portions of the plate 12 bounding opposite sides of the through hole 121 with double faced adhesive tape or glue. Distal ends of the air baffle portions 233 of one of the two air baffle members 23 can abut or come in close proximity to distal ends of the air baffle portions 233 of the other air baffle member 23. The through hole 121 is partially covered by the two air baffle members 23.

In use, cables or some small components extend through the through hole 121 between the corresponding air baffle portions 233. The corresponding air baffle portions 233 can elastically deform to allow the cables or small components to successfully extend through the through hole 121 without damaging the cables or small components. After the cables or small components extend or pass through the through hole 121, the corresponding air baffle portions 233 spring back to fill in gaps around the cables or components extending through the through hole 121, to prevent air from back flowing and turbulence. If the through hole 121 is used as an access to install an internal component, the air baffle portions 233 will fully restore after the component has passed through the through hole 121.

In other embodiments, the air baffle assembly 20 includes just one air baffle member 23 affixed to a portion of the plate 12 bounding a first side of the through hole 121. The length of the air baffle portions 233 of the air baffle member 23 is increased, to allow distal ends of the air baffle portions 233 to abut or come in close proximity to another portion of the plate 12 bounding a second side of the through hole 121 opposite to the first side. Thereby, the through hole 121 is partially covered by the air baffle member 23.

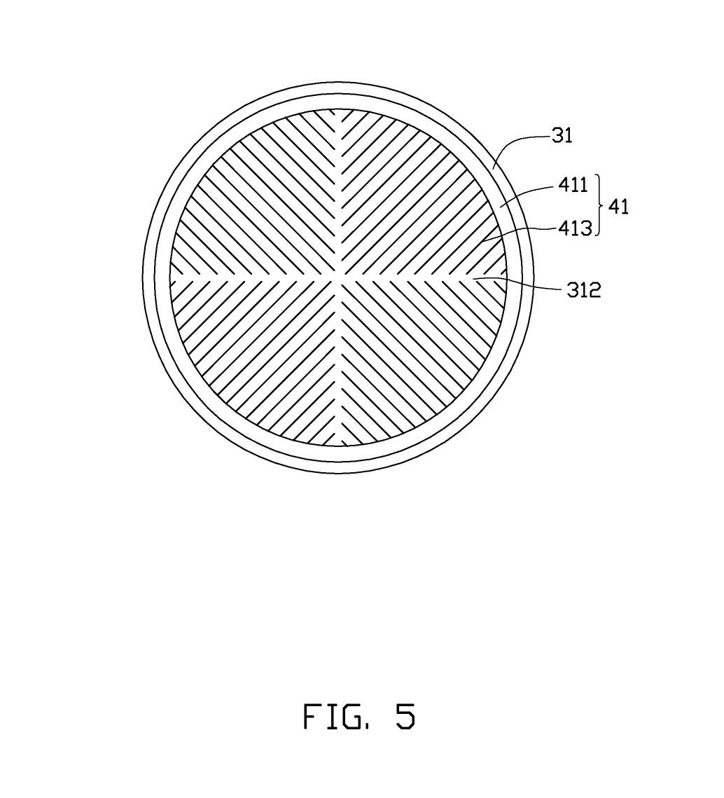

FIG. 5 shows another embodiment of an air baffle assembly and another embodiment of a plate 31 of an electronic device. The plate 31 defines a circular through hole 312. The air baffle assembly includes a circular air baffle member 41. The air baffle member 41 includes an annular flexible base 411 made of heat-resistant plastic, and a plurality of groups of bristle-shaped flexible air baffle portions 413 made of heat-resistant plastic and formed on the inner side of the base 411. Each group of air baffle portions 413 is arrayed in a fan-shape. The outer side of the base 411 is affixed to a portion of the plate 31 bounding the through hole 312 with double faced adhesive tape or glue. The air baffle portions 413 are arrayed such that the air baffle portions 413 collectively partially cover the through hole 312. Distal ends of the air baffle portions 413 can abut or come in close proximity to each other. In use, cables or some small components extend through the through hole 121 between corresponding air baffle portions 413. The corresponding air baffle portions 413 elastically deform to allow the cables or small components to successfully extend through the through hole 312 without damaging the cables or small components. After the cables or small components extend or pass through the through hole 312, the corresponding air baffle portions 413 spring back to fill in gaps around the cables or components extending through the through hole 312, to prevent air from back flowing and turbulence. If the through hole 312 is used as an access to install an internal component, the air baffle portions 413 will fully restore after the component has passed through the through hole 312.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An electronic device, comprising:
a plate defining a through hole; and
an air baffle assembly mounted in the through hole, wherein the air baffle assembly comprises at least one base mounted to a portion of the plate bounding the through hole, and a plurality of bristle-shaped flexible air baffle portions formed on the at least one base to partially cover the through hole.

2. The electronic device of claim 1, wherein the through hole is rectangular, the at least one base is one base, the base is affixed to the portion of the plate bounding a side of the through hole, and distal ends of the plurality of air baffle portions abut or come in close proximity to another portion of the plate bounding an opposite side of the through hole.

3. The electronic device of claim 1, wherein the through hole is rectangular, the at least one base is two bases, the two bases are affixed to portions of the plate bounding opposite sides of the through hole, distal ends of the air baffle portions of one of the two air baffle members abut or come in close proximity to distal ends of the air baffle portions of the other air baffle member.

4. The electronic device of claim 1, wherein the through hole is circular, at least one base is one base, the base is annular, the plurality of air baffle portions is formed on an inner side of the base, and an outer side of the base is affixed to the portion of the plate bounding the through hole.

5. The electronic device of claim 4, wherein the plurality of air baffle portions comprises a plurality of groups, each group of air baffle portions is arrayed in a fan-shape such that distal ends of the air baffle portions abut each other.

6. The electronic device of claim 1, wherein the plurality of air baffle portions is made of heat-resistant plastic.

7. The electronic device of claim 1, wherein the base is made of heat-resistant plastic.
